(19) United States
(12) Patent Application Publication
(10) Pub. No.: US 2015/0219024 A1
(43) Pub. Date: Aug. 6, 2015

(54) INTERNAL COMBUSTION ENGINE CONTROL DEVICE AND METHOD

(71) Applicant: HITACHI AUTOMOTIVE SYSTEMS, LTD., Hitachinaka-shi, Ibaraki (JP)

(72) Inventor: Yoshikuni Kurashima, Isesaki-shi (JP)

(73) Assignee: HITACHI AUTOMOTIVE SYSTEMS, LTD., Hitachinaka-shi, Ibaraki (JP)

(21) Appl. No.: 14/429,480

(22) PCT Filed: Sep. 13, 2013
(86) PCT No.: PCT/JP2013/074900

§ 371 Date: Mar. 19, 2015

(30) Foreign Application Priority Data
Sep. 21, 2012 (JP) 2012-208014

(51) Int. Cl. F02D 41/00; F02D 13/02; F02D 23/02; F01L 13/08

(52) U.S. Cl. CPC F02D 41/0005; F01L 13/08; F02D 13/0234; F02D 23/02; F02D 41/0007

(57) ABSTRACT

In an internal combustion engine equipped with a variable compression ratio mechanism, the occurrence of knocking is reduced during deceleration. When it is determined that a target compression ratio of the variable compression ratio mechanism is greater than a threshold PRSL during the deceleration, an air bypass valve interposed in a passage for bypassing a compressor of an exhaust turbo supercharger is opened to return intake air upstream (between the compressor and a throttle valve) of the throttle valve to upstream of the compressor, thereby reducing intake pressure upstream of the throttle valve and reducing in-cylinder compression pressure to reduce the occurrence of knocking.

### TECHNICAL FIELD

The present invention relates to a control device and to a method for an internal combustion engine equipped with a variable compression ratio mechanism.

### BACKGROUND ART

A variable compression ratio mechanism for varying a compression ratio has been developed to improve fuel economy of internal combustion engines. In an internal combustion engine equipped with the variable compression ratio mechanism, a usage form is common which avoids knocking or pre-ignition (knocking or the like) by setting a low compression ratio in a high load range and achieves an improvement in fuel economy by setting a high compression ratio in a low load range.

Here, when deceleration operation to make a transition from a high load state to a low load state is performed, a response delay of a compression ratio change by the variable compression ratio mechanism is less than a response delay of a decrease in intake air amount. Therefore, a highly compressed intake air and an excessive intake air amount are reached so that knocking or the like is likely to occur.

As a countermeasure against this, there has been disclosed in Patent Document 1 that in an internal combustion engine equipped with a variable compression ratio mechanism, at least either a target compression ratio or a target throttle opening is temporarily corrected to be reduced according to a required torque reduction amount during engine deceleration operation reduced in accelerator opening, to thereby reduce knocking.

### REFERENCE DOCUMENT LIST

### Patent Document

Patent Document 1: Japanese Patent Application Laid-open Publication No. 2005-155507

### SUMMARY OF THE INVENTION

### Problems to be Solved by the Invention

However, when the compression ratio is reduced, an improving effect on fuel economy by the variable compression ratio mechanism is impaired.

Furthermore, when the throttle opening is temporarily set lower than the target opening, the intake air amount is reduced more than a required value, so that the deceleration would be increased more than required. Furthermore, there is a concern that since the supercharging is performed by the inertial rotation of a turbine even if the throttle opening is reduced, a high compression ratio is reached when the throttle opening is returned to the target opening, thereby causing knocking.

The present invention has been made by paying attention to such conventional problems and aims to provide a control device and a control method configured so as to be capable of reducing knocking or the like while ensuring fuel economy and deceleration performance when deceleration operation is performed, in an internal combustion engine equipped with a variable compression ratio mechanism.

### Means for Solving the Problems

In order to achieve the above object, the present invention is:

a control device or a control method for an internal combustion engine equipped with an intake throttle valve and a variable compression ratio mechanism for varying a compression ratio, which is configured as follows:

Deceleration operation of the internal combustion engine is detected (deceleration operation detection unit). When the variable compression ratio mechanism is being operated when the engine is operated under deceleration, intake pressure upstream of the intake throttle valve is controlled to be reduced (intake pressure control unit).

### Effects of the Invention

The intake pressure upstream of the intake throttle valve is reduced when the deceleration operation of the engine is performed, to thereby reduce an increase in compression pressure of air in a cylinder even if the variable compression ratio mechanism is operated, whereby knocking can be reduced. Furthermore, satisfactory fuel economy can be ensured by the operation of the variable compression ratio mechanism and deceleration performance is also ensured since an excessive reduction in intake air amount can also be reduced.

### BRIEF DESCRIPTION OF THE DRAWINGS

FIG. 1 is a configuration diagram illustrating an engine system according to a first embodiment of the present invention.

FIG. 2 is a flowchart of control in the first embodiment.

FIG. 3 is a timing diagram illustrating the changes of various status amounts in the same control as above.

FIG. 4 is a configuration diagram illustrating an engine system according to a second embodiment of the present invention.

FIG. 5 is a flowchart of control in the second embodiment.

### MODE FOR CARRYING OUT THE INVENTION

Embodiments of the present invention will hereinafter be described with reference to the accompanying drawings.

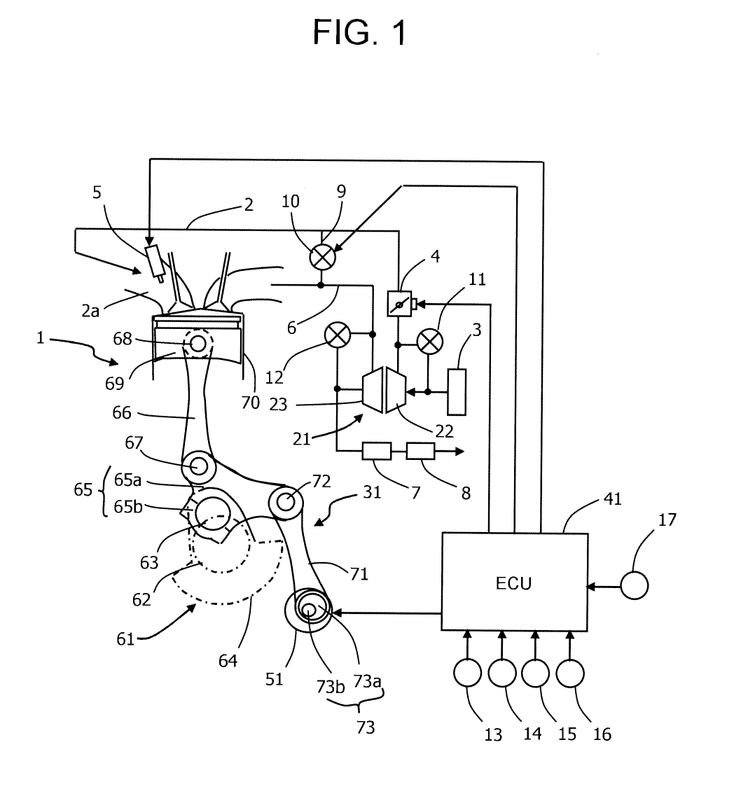

FIG. 1 illustrates an overview of an engine system according to a first embodiment.

An air cleaner 3, a compressor 22 of an exhaust turbo supercharger 21, and an electrically controlled throttle valve 4 for adjusting an intake air amount are interposed in an intake passage 2 of an engine 1 (internal combustion engine) from the upstream side, and a fuel injection valve 5 is attached to an intake port 2a portion.

A turbine 23 of exhaust turbo supercharger 21, an exhaust gas purifying catalyst 7 for purifying an exhaust, and a muffler 8 are interposed in an exhaust passage 6 from the upstream side.

An EGR passage 9 that connects exhaust passage 6 between engine 1 and exhaust gas purifying catalyst 7, to intake passage 2 downstream of throttle valve 4, is disposed. An EGR control valve 10 for adjusting an EGR amount is interposed in EGR passage 9.

An air bypass valve 11 opened under a predetermined condition is interposed in a passage, which bypasses compressor 22, of intake passage 2. A waste gate valve 12 opened under a predetermined condition is interposed in a passage, which bypasses turbine 23, of exhaust passage 6.

As described below, engine 1 is equipped with a variable compression ratio mechanism 31 that changes a compression ratio by changing the bottom dead center position of a piston by a crank mechanism through a plurality of links.

As various sensors for monitoring operating conditions of engine 1, there are provided an accelerator sensor 13 for measuring an accelerator opening, a crank angle sensor 14 for measuring an engine speed, an air-fuel ratio sensor 15 for measuring an air-fuel ratio in the exhaust gas, an airflow meter 16 for measuring an intake air amount, a throttle sensor 17 for measuring the opening of throttle valve 4, etc. Measurement signals from these sensors are input to an ECU (engine control unit) 41.

ECU 41 performs calculation based on various signals and controls throttle valve 4, EGR control valve 10, variable compression ratio mechanism 31 and fuel injection valve 5, etc.

Variable compression ratio mechanism 31 is constructed as follows.

A crank shaft 61 is provided with a plurality of journal portions 62, a crank pin portion 63 and a counterweight portion 64. Journal portion 62 is freely rotatably supported by a main bearing of a cylinder block (not illustrated) as an engine main body. Crank pin portion 63 is offset by a predetermined amount from journal portion 62. A lower link 65, which serves as a second link, is freely rotatably coupled thereto.

Lower link 65 is substantially T-shaped, and crank pin portion 63 is fitted in an approximately centered coupling hole configured to be splitable from its main body 65a and a cap 65b.

An upper link 66, which serves as a first link, has a lower end side rotatably coupled to one end of lower link 65 by a coupling pin 67, and an upper end side rotatably coupled to a piston 69 by a piston pin 68. Piston 69 reciprocates in a cylinder 70 of the cylinder block in response to combustion pressure.

A control link 71, which serves as a third link, has an upper end side rotatably coupled to the other end of lower link 65 by a coupling pin 72, and a lower end side rotatably coupled to the engine main body, for example, an appropriate position of the cylinder block through a control shaft 73. More specifically, control shaft 73 is supported by the engine body so as to rotate about a small diameter portion 73b. A lower end portion of control link 71 is fitted turnably onto a large diameter portion 73a eccentric with respect to this small diameter portion 73b.

The rotational position of small diameter portion 73b is controlled by a compression ratio control actuator 51. When small diameter portion 73b is rotated, the axial center position of large diameter portion 73a eccentric with respect to small diameter portion 73b, particularly, the relative position with respect to the engine main body, is changed. Consequently, the swing support position of the lower end of control link 71 is changed.

Then, when the swing support position of control link 71 is changed, the stroke of piston 69 is changed so that the position of piston 69 in the piston top dead center (TDC) is vertically moved.

Thus, it is possible to change the engine compression ratio. Compression ratio control actuator 51 is able to hold small diameter portion 73b at any turning position against a reaction force applied from control link 71. As compression ratio control actuator 71, a hydraulic vane-type actuator, an electric actuator or the like is used.

The control of variable compression ratio mechanism 31 configured as described above will next be described.

Basically, a target compression ratio of variable compression ratio mechanism 31 is calculated by search or the like from maps on the basis of an engine speed and an engine load (accelerator opening of accelerator, throttle opening, intake air amount or the like) corresponding to the operating conditions of engine 4. Thus, the position of the other end of control link 71 (small diameter portion 73b) is displaced relative to the engine main body to change the compression ratio to a target value.

Here, the target compression ratio is set to a low pressure ratio to avoid knocking or the like in a high load range and a high pressure ratio to improve fuel economy in a low load range.

However, when deceleration operation for reducing the accelerator opening is performed, the intake pressure upstream of throttle valve 4 is temporarily increased so that the pressure of intake air supplied to the cylinder continuously and the intake air amount are increased temporarily. Therefore, when the target compression ratio is set to the high compression ratio by variable compression ratio mechanism 31 in the low load range in which the deceleration operation is performed, the compression pressure in the cylinder is increased and the trend of occurrence of knocking or the like is increased. In particular, as in the present embodiment, the engine equipped with turbo supercharger 21 causes an increase in the trend of occurrence of knocking or the like because the intake pressure (supercharging pressure) upstream of throttle valve 4 is temporarily greatly increased when the deceleration operation is performed.

Therefore, in the present embodiment, when variable compression ratio mechanism 31 is operated to make a change to the high compression ratio when the deceleration operation is performed, ECU 41 performs control to decrease the intake pressure upstream of throttle valve 4 and thereby prevents the in-cylinder compression pressure from increasing, to reduce knocking or the like.

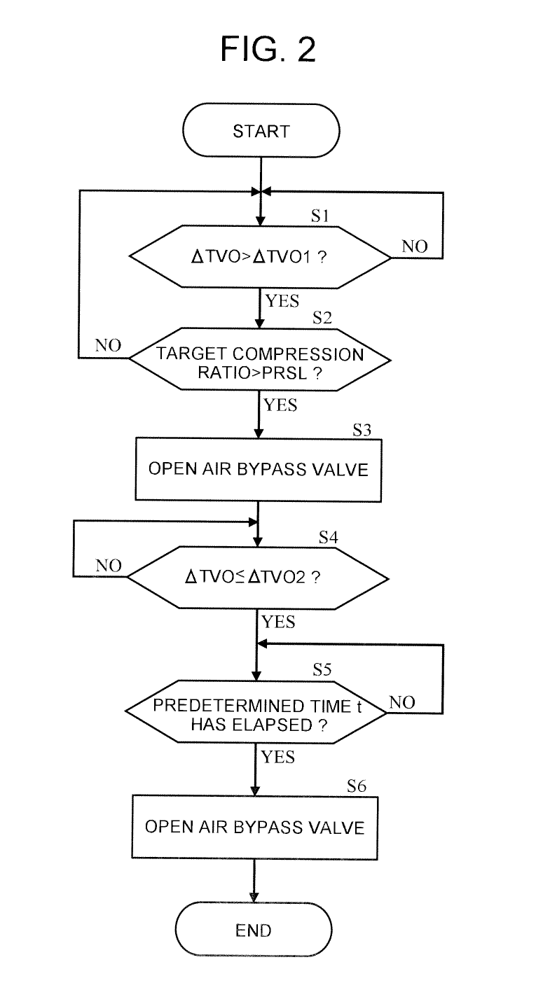

FIG. 2 illustrates a flowchart of the above control by ECU 41.

In Step S1, it is determined whether engine 1 is in deceleration operation. It is assumed to be a condition for establishment of a deceleration determination that, for example, a reduction rate ΔTVO of throttle opening TVO measured by throttle sensor 17 is a threshold value ΔTVO1 or more. Alternatively, in addition to this condition, it may be assumed to be an establishment condition that an engine speed NE or a vehicle speed is a predetermined value or more.

When it is determined in Step S1 that engine 1 is in the deceleration operation, the process proceeds to Step S2.

In Step S2, it is determined whether the target compression ratio of variable compression ratio mechanism 31 is greater than a threshold value PRSL.

Since the load is reduced more than before the deceleration operation and the target compression ratio is increased during the deceleration operation, variable compression ratio mechanism 31 is operated in such a manner that the target compression ratio is increased to threshold value PRSL or more from the state of less than threshold value PRSL.

Then, when the determination of Step S2 is YES, i.e., variable compression ratio mechanism 31 is operated when the deceleration operation is performed, the process proceeds to Step S3, in which air bypass valve 11 is opened. With the opening of air bypass valve 11, a part of the intake air supercharged between compressor 22 and throttle valve 4 is returned to the upstream side of compressor 22, so that the intake pressure (supercharging pressure) upstream (between compressor 22 and throttle valve 4) of throttle valve 4 is decreased.

In Step S4, it is determined whether the reduction rate ΔTVO of the throttle opening TVO is reduced to a threshold valve ΔTVO2 or less.

In Step S4, when it is determined that the reduction rate ΔTVO of the throttle opening TVO is reduced to the threshold value ΔTVO2 or less, the process proceeds to Step S5.

In Step S5, it is determined whether the time from the reduction to the threshold value ΔTVO1 or less has elapsed by a predetermined time t. If it is determined that the predetermined time t has elapsed, air bypass valve 11 is closed. That is, after the deceleration operation has been completed, air bypass valve 11 is closed after the elapse of the predetermined time t set in such a manner that the inertial rotation of turbine 23 is ceased and the increase in the intake pressure upstream of throttle valve 4 is reduced even if air bypass valve 11 is closed.

If done in this way, when the deceleration operation is performed, even if the intake pressure (supercharging pressure) upstream of throttle valve 4 is increased due to a decrease in throttle opening, the intake air in this part is returned to the upstream side of compressor 22 through opened air bypass valve 11.

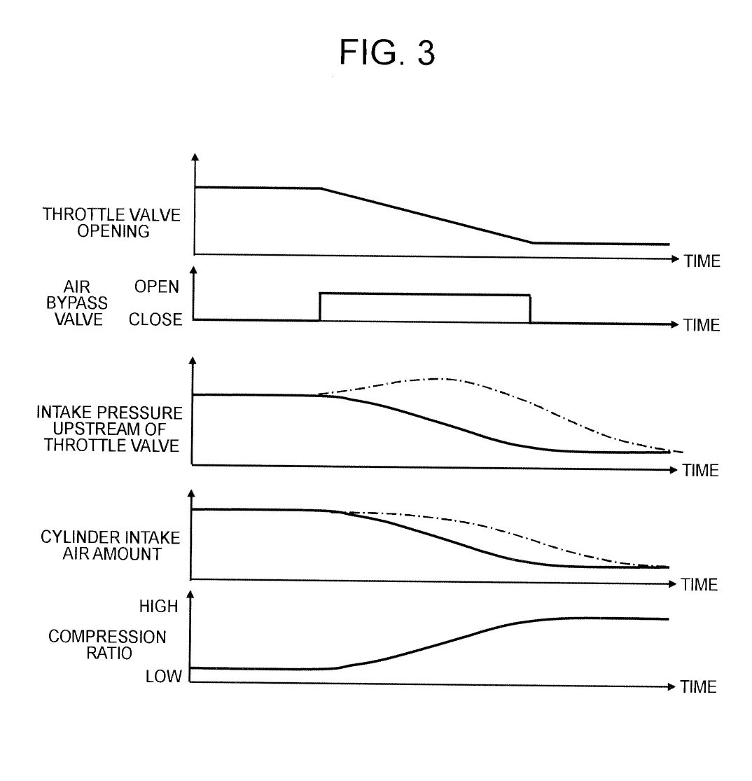

Thus, the increase in the intake pressure (supercharging pressure) upstream of throttle valve 4 is reduced, and the increase in the intake pressure and intake air amount to the cylinder can be reduced. Therefore, as illustrated in FIG. 3, even if the compression ratio is increased due to the increase in the target compression ratio of variable compression ratio mechanism 31 when the deceleration operation is performed, the increase in the compression pressure in the cylinder air is reduced and the occurrence of knocking or the like can hence be reduced.

Also, variable compression ratio mechanism 31 is capable of ensuring excellent fuel economy by normally operating. Furthermore, since the throttle opening also needs not to be reduced to the target opening or more, an excessive decrease in the intake air amount can also be reduced and deceleration performance is also ensured.

Air bypass valve 11 is opened to reduce the influence on components or the like due to an excessive rise in the upstream pressure of throttle valve 4 when the deceleration operation is performed, even as normal control, but the normal control does not taken into consideration the reduction of knocking or the like accompanying an increase in the compression ratio by variable compression ratio mechanism 31, securing of the deceleration performance, etc. Accordingly, the condition for the valve opening in the normal control is an engine speed, etc. in addition to the reduction rate of the throttle opening and does not include the operation of the variable compression ratio mechanism 31.

In the above embodiment, even when air bypass valve 11 is not opened in the normal control, it is opened under the condition in which the variable compression mechanism is operated to increase the compression ratio, thereby making it possible to reduce the knocking or the like while ensuring the fuel economy and deceleration performance.

In Step S2, it may be determined whether the amount of an increase in the target compression ratio is the threshold value or more. It may also be determined whether an actual compression ratio (or the amount of its increase) is the threshold value or more, but the operation of variable compression ratio mechanism 31 is determined more promptly by using the target compression ratio (or the amount of its increase) to reduce the intake air pressure upstream of the throttle valve, thereby making it possible to improve an knocking avoidance effect.

Furthermore, in Step S3, waste gate valve 12 is opened instead of air bypass valve 11 to reduce the rotational speed of turbine 23, whereby the intake pressure upstream of throttle valve 4 may be decreased. However, the intake pressure upstream of the throttle valve is directly reduced by the opening of air bypass valve 11 to enable the knocking or the like to be avoided with more favorable responsiveness. Furthermore, the opening of air bypass valve 11 and the opening of waste gate valve 12 may be used jointly. For example, when air bypass valve 11 may be opened when the target compression ratio (actual compression ratio) is greater than a first threshold value, and waste gate valve 12 may also be opened when the target compression ratio has reached more than a second threshold value greater than the first threshold value.

Although waste gate valve 12 is opened when a request to reduce the intake pressure in an intake manifold has occurred in the normal control, the operation of variable compression ratio mechanism 31 is not defined as the condition for valve opening as with the normal control of air bypass valve 11. Thus, even when waste gate valve 12 is not opened in the normal control, it is opened under the condition in which variable compression ratio mechanism 31 is operated to increase the compression ratio, thereby make it possible to reduce the knocking or the like while ensuring the deceleration performance.

When applied to the engine equipped with the turbo supercharger as in the above first embodiment, a higher knocking suppression effect is obtained by reducing the increase in the supercharging pressure upstream of throttle valve 4 at the time of the deceleration operation. The knocking reduction effect is, however, obtained by applying to one provided with means capable of suppressing an increase in intake pressure when the deceleration operation is performed, even at one not equipped with the supercharger.

For example, in an engine brought to high charging efficiency by drawing air having a positive pressure wave (pulsating pressure) that is high at the low load into the cylinder by inertial supercharging (or resonance supercharging, hereinafter typified by inertial supercharging), when the compression ratio is variably controlled by providing it with a variable compression ratio mechanism, an increase in compression ratio and an increase in intake air amount overlap when the deceleration operation corresponding to the low load is performed, so that the tendency to generate knocking is increased.

Therefore, in this type of engine, the inertial supercharging is stopped when the deceleration operation is performed, to thereby make it possible to reduce the increase in the intake pressure and obtain the knocking reduction effect.

A description will hereinafter be made about a second embodiment that performs inertial supercharging and is applied to an engine equipped with a variable compression ratio mechanism.

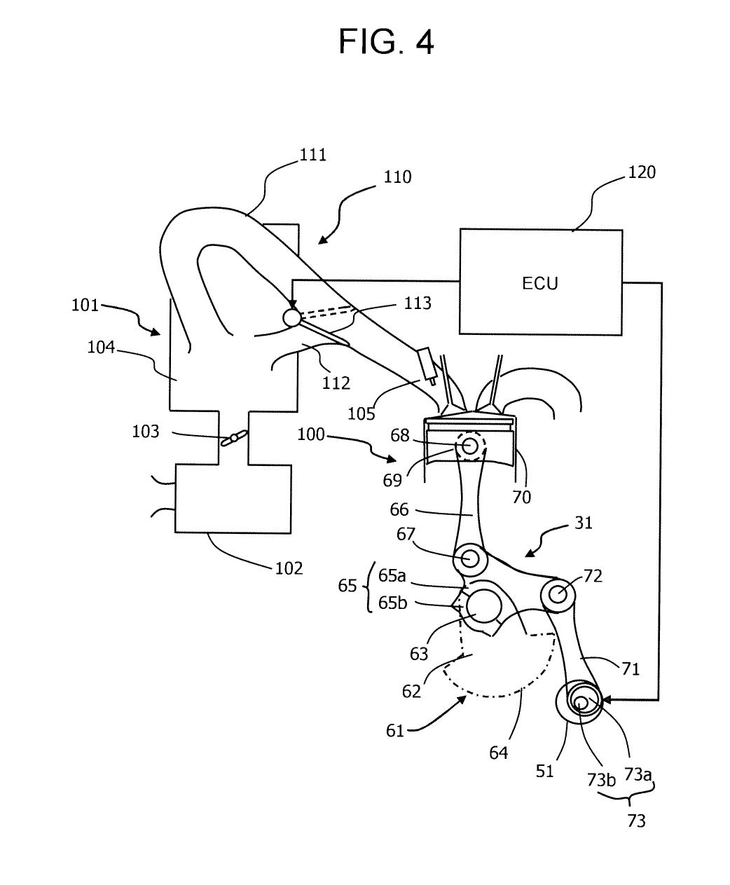

FIG. 4 illustrates an overview of an engine system according to the second embodiment. The description of components common to the first embodiment will be omitted.

An engine 100 includes an inertial supercharging mechanism 110 provided in an intake passage 101.

A passage leading from an air cleaner 102 via a throttle valve 103 and an intake collector 104 to an intake port 105 serves as intake passage 101. Inertial supercharging mechanism 110 is provided at a portion leading from intake collector 104 to intake port 105.

Inertial supercharging mechanism 110 includes a first passage 111 that has a long passage length and a second passage 112 that has a short passage length. First passage 111 and second passage 112 are connected to each other in parallel at a downstream portion of intake passage 101. Inertial supercharging mechanism 110 further includes a passage switching valve 113 provided at the downstream portion and that is controlled to selectively open first passage 111 and second passage 112.

In the normal control, by a command from ECU120, first passage 111 that has a long passage length is opened by passage switching valve 113 such that the inertial supercharging adapted to a low speed/low load range of engine 100 is performed in the low speed/low load range. Furthermore, second passage 112 that has a short passage length is opened in such a manner that in a high speed/high load range, inertial supercharging adapted to the high speed/high load range is performed or the normal intake not using the inertial supercharging is performed.

Here, even in the case of the deceleration operation corresponding to the low load, when a variable compression ratio mechanism 31 is operated to increase the compression ratio, second passage 112 that has a short passage length is opened by passage switching valve 113.

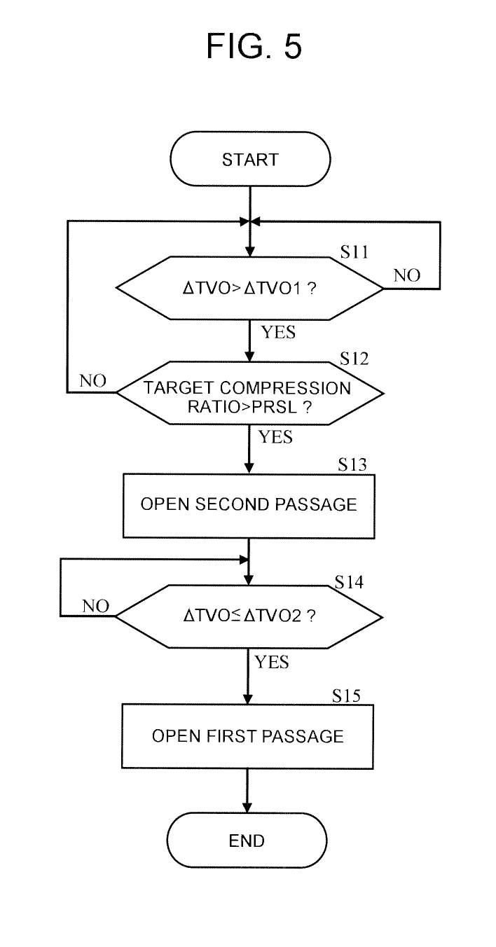

FIG. 5 illustrates a flowchart of control in the present second embodiment.

Steps S11 and S12 are similar to Steps S1 and S2 in the first embodiment. When it is determined that the target compression ratio of variable compression ratio mechanism 31 is greater than a threshold value PRSL during the deceleration operation, the process proceeds to Step S13.

In Step S13, second passage 112 is selected and opened by passage switching valve 113.

In Step S14, as with Step S4 of the first embodiment, when it is determined that a reduction ratio ΔTVO of a throttle opening TVO is reduced to less than or equal to a threshold valve ΔTVO2, the process proceeds to Step S15.

In Step S15, first passage 111 corresponding to the time of the low load is selected and opened by passage switching valve 113.

If done in this way, when variable compression ratio mechanisms 31 is operated to increase the compression ratio at the time of the deceleration operation, the inertial supercharging corresponding to the low load range is stopped by the selection of second passage 112, to thereby reduce the intake air amount and reduce an increase in in-cylinder compression pressure, to make it possible to reduce the knocking or the like. Furthermore, since satisfactory fuel economy can be ensured by operating variable compression ratio mechanism 31 and the intake air amount is not excessively reduced by stoppage of the inertial supercharging, it is possible to ensure deceleration performance according to demand.

### REFERENCE SYMBOL LIST

1, 100 Engine
2, 101 Intake passage
4 Throttle valve
17 Throttle sensor
21 Exhaust turbo supercharger
31 Variable compression ratio mechanism
41 ECU (engine control unit)
51 Compression ratio control actuator
110 Inertial supercharging mechanism
111 First passage
112 Second passage
113 Passage switching valve

1. A control device for an internal combustion engine, the internal combustion engine comprising an intake throttle valve and a variable compression ratio mechanism capable of varying a compression ratio,
the control device comprising:
a deceleration operation detection unit that detects deceleration operation of the internal combustion engine; and
an intake pressure control unit that reduces intake pressure upstream of the intake throttle valve when the variable compression ratio mechanism is operated when the deceleration operation of the internal combustion engine is performed.

2. The control device for the internal combustion engine, according to claim 1, wherein the intake pressure control unit reduces the intake pressure upstream of the intake throttle valve when the variable compression ratio mechanism is operated in a direction to increase the compression ratio.

3. The control device for the internal combustion engine, according to claim 1, wherein the intake pressure control unit reduces the intake pressure upstream of the intake throttle valve as the compression ratio increases.

4. The control device for the internal combustion engine, according to claim 1, wherein when a target compression ratio of the variable compression ratio mechanism is greater than a threshold value when the deceleration operation is performed, the intake pressure control unit reduces the intake pressure upstream of the throttle valve.

5. The control device for the internal combustion engine, according to claim 1, wherein when an amount of an increase in a target compression ratio of the variable compression ratio mechanism is greater than a threshold value when the deceleration operation is performed, the intake pressure control unit reduces the intake pressure upstream of the throttle valve.

6. The control device for the internal combustion engine, according to claim 1, wherein the internal combustion engine is equipped with an exhaust turbo supercharger, and
wherein the intake pressure control unit performs a reduction in the intake pressure upstream of the intake throttle value by opening an air bypass valve interposed in a passage for bypassing a compressor of the exhaust turbo supercharger.

7. The control device for the internal combustion engine, according to claim 1, wherein the internal combustion engine is equipped with an exhaust turbo supercharger, and
wherein the intake pressure control unit performs a reduction in the intake pressure upstream of the intake throttle valve by opening a waste gate valve interposed in a passage for bypassing a turbine of the turbo supercharger.

8. The control device for the internal combustion engine, according to claim 6, wherein after the air bypass valve is opened when the deceleration operation is performed, the intake pressure control unit closes the air bypass valve after the elapse of a predetermined time.

9. The control device for the internal combustion engine, according to claim 7, wherein after the waste gate valve is opened when the deceleration operation is performed, the intake pressure control unit closes the waste gate valve after the elapse of a predetermined time.

10. The control device for the internal combustion engine, according to claim 1, wherein the internal combustion engine is equipped with an exhaust turbo supercharger, and
wherein when a target compression ratio of the variable compression ratio mechanism becomes greater than a first threshold value when the deceleration operation is performed, the intake pressure control unit opens an air bypass valve interposed in a passage for bypassing a compressor of the turbo supercharger, and when the target compression ratio becomes greater than a second threshold value greater than the first threshold value, the intake pressure control unit opens a waste gate valve interposed in a passage for bypassing a turbine of the turbo supercharger, to reduce the intake pressure upstream of the intake throttle valve.

11. The control device for the internal combustion engine, according to claim 1, wherein the internal combustion engine is equipped with an inertial supercharging mechanism,
wherein the inertial supercharging mechanism comprising: a first passage that has a short passage length and a second passage that has a long passage length, the first and second passages being connected to each other in parallel at a downstream portion of an intake passage; and a passage switching valve provided at the downstream portion and that is controlled to selectively open the first passage and the second passage,
wherein when the variable compression ratio mechanism is operated in a direction to increase the compression ratio when the deceleration operation is performed, the intake pressure control unit selects and opens the second passage.

12. A control method for an internal combustion engine equipped with an intake throttle valve and a variable compression ratio mechanism capable of varying a compression ratio, comprising the steps of:
detecting deceleration operation of the internal combustion engine; and
controlling intake pressure upstream of the intake throttle valve to be reduced when the variable compression ratio mechanism is operated when the deceleration operation of the internal combustion engine is performed.

13. The control method for the internal combustion engine, according to claim 12, wherein the step of controlling the intake pressure to be reduced reduces the intake pressure upstream of the intake throttle valve when the variable compression ratio mechanism is operated in a direction to increase the compression ratio.

14. The control method for the internal combustion engine, according to claim 12, wherein the step of controlling the intake pressure to be reduced reduces the intake pressure upstream of the intake throttle valve as the compression ratio increases.

15. The control method for the internal combustion engine, according to claim 12, wherein the step of controlling the intake pressure to be reduced reduces the intake pressure upstream of the throttle valve when a target compression ratio of the variable compression ratio mechanism is greater than a threshold value when the deceleration operation is performed.

16. The control method for the internal combustion engine, according to claim 12, wherein the step of controlling the intake pressure to be reduced reduces the intake pressure upstream of the throttle valve when an amount of an increase in the target compression ratio of the variable compression ratio mechanism is greater than a threshold value when the deceleration operation is performed.

17. The control method for the internal combustion engine, according to claim 12, wherein the internal combustion engine is equipped with an exhaust turbo supercharger, and
wherein the step of controlling the intake pressure to be reduced opens an air bypass valve interposed in a passage for bypassing a compressor of the turbo supercharger, to thereby reduce the intake pressure upstream of the intake throttle valve.

18. The control method for the internal combustion engine, according to claim 12, wherein the internal combustion engine is equipped with an exhaust turbo supercharger, and
wherein the step of controlling the intake pressure to be reduced opens a waste gate valve interposed in a passage for bypassing a turbine of the turbo supercharger, to thereby reduce the intake pressure upstream of the intake throttle valve.

19. The control method for the internal combustion engine, according to claim 12, wherein the internal combustion engine is equipped with an exhaust turbo supercharger, and
wherein the step of controlling the intake pressure to be reduced opens an air bypass valve interposed in a passage for bypassing a compressor of the turbo supercharger when a target compression ratio of the variable compression ratio mechanism becomes greater than a first threshold value when the deceleration operation is performed, and opens the waste gate valve interposed in a passage for bypassing a turbine of the turbo supercharger to reduce the intake pressure upstream of the intake throttle valve when the target compression ratio becomes greater than a second threshold value greater than the first threshold value.
